(19) United States
(12) Patent Application Publication
(10) Pub. No.: US 2020/0119569 A1
(43) Pub. Date: Apr. 16, 2020

(54) Rechargeable Battery Generator for Commercial, Industrial and Military Applications

(71) Applicant: Sergio Lima, Orlando, FL (US)

(72) Inventor: Sergio Lima, Orlando, FL (US)

(21) Appl. No.: 16/563,154

(22) Filed: Sep. 6, 2019

Related U.S. Application Data
(60) Provisional application No. 62/745,335, filed on Oct. 13, 2018.

(51) Int. Cl. H02J 7/00; H02J 7/02; H02J 7/35; H01M 10/46; H01M 10/48

(52) U.S. Cl. CPC H02J 7/0045; H02J 7/0047; H01M 10/48; H02J 7/35; H01M 10/465; H02J 7/02

(57) ABSTRACT

The present invention discloses a rechargeable power storage system which is based on the principal of traditional generator and is able to produce large amount of energy for longer period of time without using gasoline, fossil fuels or other external power sources. The battery can be charged through electric vehicle charging system, electric outlets or by a modular scalable solar supply. The assembly can be transported and used in severe weather related situations when homeowners or rescue teams are faced with catastrophic environmental events, having no available source of power or gasoline for days or weeks. Also when troops are submitted to longer than expected missions putting their lives in even more danger when faced without any source of power and finally when working crews are directed to jobs hundreds of miles from populated areas with no electricity or gas stations in order to run their heavy duty tools. For all those extreme situations or just to be a permanent replacement for a heavy-duty gas generator, this modular, environmentally friendly, flexible power storage system is the answer.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark (Vice patent files or records, but otherwise reserves all copyright rights whatsoever.

### BACKGROUND

### Field of the Invention

The invention herein relates to methods for supplying large amounts of power to any equipment, including high ampere, high voltage heavy duty equipment for long periods of time without the use of fossil fuels. More particularly it relates to an assembly of a rechargeable power storage system to be used as a generator of power stored on a battery system inside the unit. The unit is capable of supplying large amounts of power to any equipment for long periods of time without the use of fossil fuels.

### Description of the Related Art

Electrical power can be produced by an electric generator from other sources of energy such as, for example, wind, flowing water, engines, or human or animal power. In some cases, the source of energy is intermittent and/or fluctuating rather than substantially continuous. Even with a proliferation of different energy sources, most areas in the world are still suffering from lack of coverage from the power grid and even on most advanced nations, less populated areas are still living without the proper energy source of electricity. The problem of having a source of power that is steady and reliable confronts everyone, including consumers, industry, the government and the military.

There are many inventions that have been found in prior art that focus on providing power supply to electrical apparatus when the energy flow is not readily available. For instance, a Hybrid energy storage system invention bearing U.S. Pat. No. 5,916,699A is issued to Motorola Solutions Inc. The system discloses an energy storage system (10) including a first energy storage device (12), such as a secondary or rechargeable battery, and a second energy storage device (14), such as a capacitor, fuel cell, or flywheel. The second energy storage device provides intermittent energy bursts to satisfy the power requires of, for example, pulsed power communication devices. Such devices typically require power pulses in excess of those which conventional battery cells can easily provide for numerous cycles. The system (10) further includes circuitry (16) for coupling the second energy storage device (14) to a load in response to changes in the battery (12).

A U.S. Pat. No. 6,664,759B1 is issued to Hewlett-Packard Development Co LP is a manually rechargeable power system A manually rechargeable power system includes a generator operable to generate electrical energy. A capacitor is operable to store the electrical energy generated by the generator. The generator and/or capacitor may be housed in a housing configured to replicate a size and a shape of one or multiple batteries.

A U.S. Pat. No. 5,196,275A is an Electrical power storage apparatus is issued to Electric Fuel (EFL) Ltd. The system discloses an electrical power storage unit has one or more metal-gas electrical cells, each cell including a pair of generally planar outer electrode units configured to define there between an interior space for containing an electrical power storage medium and an inner electrode unit mounted between the pair of outer electrode units so as to be in electrically conductive contact with the electrical power storage medium and define a plurality of volumes each having a pair of open ends, each open end facing an adjacent outer electrode unit. The power storage medium is a slurry containing active metal particles and an electrolyte solution. The inner electrode unit is configured for removable insertion within the interior space. The volumes defined by the inner electrode unit are configured so as to contain portions of the power storage slurry such that removal of the inner electrode unit from the interior space causes the simultaneous removal therefrom of the major part of the power storage slurry. Each outer electrode unit includes a generally planar gas electrode, a device for separating the metal particles from the gas electrode, and a device for preventing mechanical damage to the device for separating upon removal of the inner electrode unit from the interior space and upon insertion of the inner electrode unit into that space.

A U.S. Pat. No. 7,009,350B1 is issued to Great Systems Inc is an Energy collection and storage system. The system discloses a power generation and/or storage device utilizes human motion inputs or other power sources (i.e. hydraulics, pneumatics or explosive gases) to create mechanical kinetic energy that is stored (preferably in springs) and later released on demand to rotate a generator to produce electricity.

A U.S. Pat. No. 2,012,026,8074A1 is issued to FASTCAP SYSTEMS CORP is a Power system for high temperature applications with rechargeable energy storage. A power system adapted for supplying power in a high temperature environment is disclosed. The power system includes a rechargeable energy storage that is operable in a temperature range of between about seventy degrees Celsius and about two hundred and fifty degrees Celsius coupled to a circuit for at least one of supplying power from the energy storage and charging the energy storage; wherein the energy storage is configured to store between about one one hundredth (0.01) of a joule and about one hundred mega-joules of energy, and to provide peak power of between about one one hundredth (0.01) of a watt and about one hundred megawatts, for at least two charge-discharge cycles. Methods of use and fabrication are provided. Embodiments of additional features of the power supply are included.

A U.S. Pat. No. 7,658,247B2 is issued to GATEKEEPER SYSTEMS Inc discloses systems and methods for power storage and management from intermittent power sources. It is a power management system is disclosed. Embodiments of the power management system may be configured for use with an electric generator that produces AC or DC voltage from an energy source, which may be intermittent or fluctuating. One embodiment of the power management system includes an energy storage reservoir configured to be electrically coupled to the electric generator. The energy storage reservoir includes at least one ultra-capacitor and at least one rechargeable battery. The power management system also includes an electronic controller configured to control storage in the reservoir of energy generated by the electric generator and to control power usage from the reservoir and the generator. The electronic controller is configured to control energy storage and power usage in response to one or more control signals.

An Energy storage system bearing U.S. Pat. No. 5,738,919A is issued to Motorola Solutions Inc. The system discloses a hybrid energy storage system (10) including a first energy storage device (12), such as a secondary or rechargeable battery, and a second energy storage device (14), such as an electrochemical capacitor. The electrochemical capacitor provides intermittent energy bursts to satisfy the power requires of, for example, pulsed power communication devices. The first and second energy storage devices are coupled to a current controller to assure that pulse transients are not applied to the battery cell as a result of charging the capacitor.

A U.S. Pat. No. 7,699,102B2 is a rechargeable energy storage device in a downhole operation. In some embodiments, an apparatus includes a tool for a downhole operation. The tool includes an electrical component. The tool includes a rechargeable energy storage device to supply power to the electrical component. The tool also includes a generator to supply power to the electrical component.

A Portable wind power generator bearing U.S. Pat. No. 7,339,286B1 is issued to Shih H Chen. The patent discloses a portable wind power generator capable of being stored in a folded manner includes a storage case and a power-generating system. The power-generating system is disposed in the storage case. The storage case includes a case body and a plurality of covers. The case body and the plurality of covers form a hollow accommodating space. Further, the power-generating system includes a power-generating unit, an electricity unit, a vane assembly and a storage unit. The vane assembly is disposed in the accommodating space in a folded manner. The power-generating unit is connected with the vane assembly. The electricity unit and the storage unit are mounted on the case body, respectively. Each component of the power-generating unit is electrically connected to one another. With the wind force generated by the vane assembly, the power-generating unit can be driven to generate the electricity, thereby to supply the electricity to the user and facilitate the carrying of the wind power generator.

It has to be noted that the current invention proposes an advancement in rechargeable power storage systems which is used to generate large amount of power on the go to even heavy-duty power equipment for longer period of time without using external resources like gasoline or any fossil fuel. The invention proposes a fundamental advancement where the assembly will be pre-charged with power from electric sources like Electric Vehicle charging stations, home or business electric outlet or by an add on solar system. The system replaces fossil fuels power generators with rechargeable power stored on a battery system. Furthermore, the system is more likely to be carry on military vehicles, professional trucks or vans while on the field using tools or equipment.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### DETAILED DESCRIPTION OF THE INVENTION

Disclosed herein is a power generator that provides electrical energy from a battery based system. [1] A modular battery system made of several individual rechargeable cells form the whole battery package, which stores the electricity to be used. [2] Protection fuses are part of the system to protect every single battery cell inside the system. [3] A regular 120/240 v battery charger unit is used to charge the batteries and is located on the outer box of the generator. [4] The outer box of the generator is to be preferable in a rectangular or square shape and made of a resistant heavy-duty insulated material. [5] An optional solar charger unit could be available and located also on the outer box of the generator. [6] An optional solar charge controller should be available every time a solar charger is installed as option and will be connected to the solar charger and battery package. [7] An optional Electric Vehicle charger unit could be available and located also on the outer box of the generator. [8] An optional Electric Vehicle Quick charge controller should be available every time an Electric Vehicle Quick Charger unit is installed as option and will be connected to the Electric Vehicle Quick Charger and battery package. [9] A Chiller or a cooling system is also part of the system to help controlling the temperature of the battery cells. [10] Each Rechargeable Battery Generator will have the option to have from none to several DC/AC inverters, each protected by circuit breakers and from where Power Plugs will be attached to the front panel where heavy-duty equipment will be connected to be powered. [11] Each Rechargeable Battery Generator will have the option to have from none to several DC/DC converters, each protected by circuit breakers and from where Power Plugs will be attached to the front panel where heavy-duty equipment will be connected to be powered. [12] Each Rechargeable Battery Generator will have the option to have from none to several DC Power Plugs without the use of any convertors when using the same voltage generated by the battery system. They will be attached to the front panel where heavy-duty equipment will be connected to be powered. [13] A main processor control board is present and will house the (BMS) battery monitoring system. That will serve as controlling unit or the brain for the whole system. [14] A LCD touch screen attached to the front panel will serve as input communicator and for monitoring the system.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of high and low voltage rechargeable power storage system on the go.

The primary objective of this invention is also to provide improvements in the method of generating power whether indoor or in closed spaces outdoor.

It is another objective of the invention to provide a rechargeable power storage system to be used as a generator of power stored on a battery system inside the electric generator.

It is further the objective of the invention to provide an apparatus which will be capable to generate large amounts of power to any equipment for long periods of time without the use of fossil fuels.

It is also the objective of the invention to provide a readily charging source for the apparatus where sources can be electric vehicle charging stations, home or business electric outlets or by an add on modular scalable solar system.

It is another objective of the invention to provide a utility of system which is more likely to be carry on military vehicles, professional trucks or vans while on the field using tools or equipment.

A further object is to provide an assembly that is simple and easy to use—A plug and use system.

A still further object is to provide an assembly that is economical in cost per watt supplied and low in cost to manufacture.

It is a further object of the present invention to provide a new and improved rechargeable power supply assembly to be used indoors or outdoors, on the go, no pollutant and which is of a durable, water proof and reliable construction.

Still yet another object of the present invention is to provide a new and improved rechargeable power supply assembly which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF VIEWS OF THE DRAWINGS

Other objects and advantages will be apparent from the following description when taken in connection with the accompanying drawings in which:

FIG. 1 is a top plan view of the battery pack.

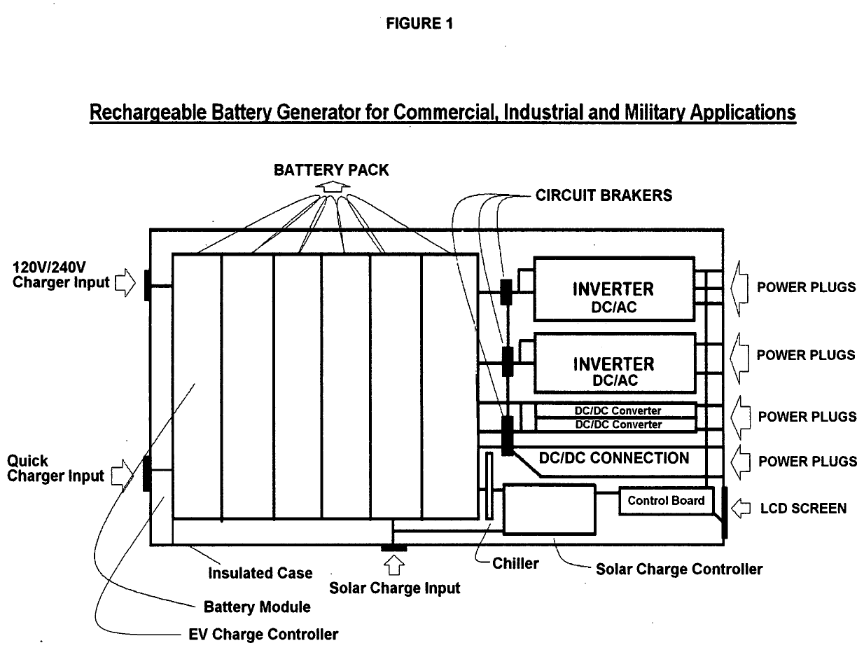

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide a heavy duty generator using a rechargeable power storage system with standardized and advanced features.

The inventions in prior art are all valuable methods to provide electrical power. However, none of them had addressed the high Kilowatt and high ampere industry. Most end users will use conventional small rechargeable batteries because of availability and convenience but they will eventually need to be recharged or multiple batteries will have to be available. But there is no electric consistent supply answer on the market for mid-sized or heavy-duty tools needing portable power, in the absence of electricity they must rely on fossil fuels generators or dozens of conventional batteries. To be popularly used, battery power generators must be made more convenient to use than conventional batteries. In order to achieve those goals, we believe that electrical power generators must be compatible with existing battery powered appliances. Such power generators should be as easy to use as conventional batteries and be more convenient to replace or recharge.

The current invention in its preferred embodiment intends to provide a system which is not only easy to use but is also convenient in its operation. The system doesn't requires gasoline or external continuous input to provide electrical energy.

The system in its preferred embodiment provides a system which is like a regular gasoline powered generator and will supply power to several equipment in need of constant power for long periods of time. The assembly will be pre-charged with power from electric sources like electric vehicle charging stations, home or business electric outlet or by solar energy. The assembly of the power system will be able to supply power on any kind of environment, inclusive indoors. The system replaces traditional gas power generators with rechargeable power stored on a battery system. The system is intended to be installed on military vehicles, professional trucks and working vans while on the field using tools or equipment.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment.

Thus, the following claims are hereby incorporated into the Detailed Description, with each claim standing on its own as a separately claimed subject matter.

I: an electrically rechargeable electric energy storage and rechargeable system where the system comprises of:
at least one high Ampere battery cell which is rechargeable;
An inverter system connected to the battery cell(s) and capable of handling low or high Ampere equipment;
a front panel with several types of power plugs;
an lcd screen programmed to give user information about the usage and to monitor the system.

II: An energy storage reservoir configured to be electrically coupled to the electric generator to provide nonstop electric flow to the desired apparatus.

III: A rechargeable power supply unit which can be charged from any electrical input including electric vehicle charging stations, home or business electric outlet or by an add on modular scalable solar system. The system replaces the need of fossil fuel power generators with rechargeable power stored on a battery system.
